(19) United States
(12) Patent Application Publication
(10) Pub. No.: US 2010/0071980 A1
(43) Pub. Date: Mar. 25, 2010

(54) ELECTRIC POWER STORAGE APPARATUS AND CAR

(75) Inventors: Jun Kokaji, Toyota-shi (JP); Hirokazu Kawai, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, AICHI-KEN (JP)

(21) Appl. No.: 12/445,554

(22) PCT Filed: Oct. 29, 2007
(86) PCT No.: PCT/JP2007/071438

§ 371 Date: Apr. 14, 2009

(30) Foreign Application Priority Data
Nov. 2, 2006 (JP) 2006-299422

(51) Int. Cl. B60R 16/04

(52) U.S. Cl. 180/68.5

(57) ABSTRACT

An electric power storage apparatus provided in a cabin includes a battery pack for storing electric power, and an air inlet duct for cooling the battery pack. The air inlet duct is formed to extend in the front-back direction of the car body. The air inlet duct includes an air inlet port formed in its end portion in the front-back direction of the car body and located within the cabin. The air inlet port is formed to let the air flow in a direction substantially perpendicular to the front-back direction of the car body.

### TECHNICAL FIELD

The present invention relates to an electric power storage apparatus and a car.

### BACKGROUND ART

In recent years, a hybrid car, in which a motor serving as a drive source and another drive source (for example, an internal combustion engine, a fuel cell, or the like) are combined, has been put into practical use. In addition, an electric car employing a motor as a drive source has been considered. In such cars, an electric power storage apparatus is installed to supply the motor with electric power, which is energy. The electric power storage apparatus includes an electric power storage device for storing electric power. The electric power storage device provided therein is, for example, a secondary battery, a capacitor, or the like that can be charged and discharged repeatedly.

As the secondary battery, a nickel-cadmium battery, a nickel-hydrogen battery, a lithium-ion battery, or the like is used. The secondary battery is constituted by, for example, stacked battery cells. The secondary battery is contained in a battery case and is installed in a car.

The electric power storage device in the electric power storage apparatus generates heat, which rises temperature therein. For example, at a high temperature, the secondary battery's power generation efficiency is decreased. Hence, to cool the secondary battery, external cooling air is introduced into the case containing the secondary battery. In some electric power storage apparatuses, an air sending device, such as a fan, a duct, or the like, for introducing cool air or warm air thereinto is installed to control the temperature of the electric power storage device.

In recent years, it has been considered to place such an electric power storage apparatus within the cabin, not outside the cabin. The placement of the electric power storage apparatus within the cabin advantageously achieves, for example, widening of a trunk room, in which the electric power storage apparatus had been placed.

Japanese Patent Laying-open 2004-345447 discloses an in-vehicle structure in which a battery outer case, a high voltage electrical component, is provided in the center of a floor panel in the width direction of the vehicle. The battery outer case is positioned, on a center tunnel extending in the front-back direction of the vehicle, between seats arranged side by side in the width direction of the vehicle.

Japanese Patent Laying-open 2005-1655 discloses a structure in which a high voltage electrical component case is provided on a floor of a car body between the driver's seat and the passenger's seat arranged side by side in the width direction of the car.

Japanese Patent Laying-open 2001-354039 discloses a vehicular electric power source apparatus to which air is introduced from a slit provided in a below-seat cover panel in order to cool a battery pack provided in a location neighboring the cabin with the below-seat cover panel interposed therebetween.

Japanese Patent Laying-open 2004-237803 discloses a vehicular battery mounted structure in a vehicle having a first battery pack and a second battery pack installed therein. The second battery pack is used in an environment severer in the temperature requirement than the first battery pack. The first battery pack is mounted within an engine compartment whereas the second battery pack is mounted below a seat on which an occupant of the vehicle other than the driver sits. With a space between the battery cells used as a cooling path, air flows from the central side in the width direction of the vehicle to the outside.

Japanese Patent Laying-open 2005-7915 discloses a battery pack cooling structure having a first rib, a second rib, and a third rib for guiding cooling air from a battery pack in the rightward and leftward directions of a vehicle. The first rib, the second rib, and the third rib are provided on the lower surface of a floorboard provided on a floor panel with a predetermined interval therebetween in the height direction to form the cabin's internal floor surface. The first rib, the second rib, and the third rib are provided perpendicularly to the lower surface of the floorboard.

If the electric power storage apparatus is placed within the cabin, it has been considered to cool the electric power storage apparatus using air in the cabin or to exhaust the air used for the cooling into the cabin.

The electric power storage apparatus is provided with electric devices such as a relay for turning on or turning off an electric circuit, an inverter, and the like. These electric devices generate noise resulting from ripple current or the like. Furthermore, a fan for sending cooling air generates noise when being driven.

Unfortunately, if the electric power storage apparatus is placed within the cabin, an occupant in the cabin hears the noise generated by the electric devices and the fan. Such noise is emitted mainly from an air inlet port or an air outlet port of the electric power storage apparatus toward the cabin, and the occupant hears it accordingly.

### DISCLOSURE OF THE INVENTION

It is an object of the present invention to provide an electric power storage apparatus allowing for noise suppression in a cabin.

An electric power storage apparatus of the present invention is provided in a cabin and includes an electric power storage device for storing electric power. The electric power storage apparatus includes a duct, in which air flows to cool the electric power storage device. The duct is formed to extend in one direction. The duct has an opening formed in an end portion thereof in the one direction and located within the cabin. The opening is formed to let the air flow in a direction substantially perpendicular to the one direction.

In the invention, it is preferable that the electric power storage apparatus include a flow path plate provided within the duct. The flow path plate is formed to extend in the one direction.

In the invention, it is preferable that the opening include one of an air inlet port and an air outlet port. The duct includes one of an air inlet duct and an air outlet duct.

In the invention, it is preferable that the electric power storage apparatus include an acoustical material for absorbing noise. The opening is formed on a wall surface of the duct, the wall surface being substantially parallel to the one direction. The acoustical material is provided on an end surface of the duct in the one direction.

In the invention, it is preferable that the electric power storage apparatus include a reflecting member for reflecting noise. The reflecting member is provided in the opening. The reflecting member is formed to have a plate-like shape. The reflecting member has a surface having a maximal area and is disposed with the surface inclining relative to the one direction.

In the invention, it is preferable that the electric power storage device include a plurality of storage cells. In the electric power storage device, the plurality of storage cells are stacked in the one direction.

A car of the present invention includes the electric power storage apparatus. In the invention, it is preferable that the car include a plurality of seats arranged in a width direction of a car body. The electric power storage apparatus is positioned between the plurality of seats. The duct is formed to extend in a front-back direction of the car body.

In the invention, it is preferable that the car include a floor member provided within the cabin. The duct is formed to extend in a front-back direction of the car body. The opening is formed to face downward in a vertical direction. The opening is formed to face the floor member.

In the invention, it is preferable that the car include an extending duct extending from the opening of the duct in the perpendicular direction. The extending duct has a tip portion formed to extend to below the seats.

According to the present invention, an electric power storage apparatus allowing for noise suppression in a cabin can be provided.

Note that two or more of the above configurations may be combined appropriately.

### BRIEF DESCRIPTION OF THE DRAWINGS

FIG. 1 is a schematic perspective view of a cabin in a first embodiment.

FIG. 2 is a schematic perspective view of a first electric power storage apparatus in the first embodiment.

FIG. 3 is a schematic perspective view of a portion of air outlet ducts of the first electric power storage apparatus in the first embodiment. FIG. 4 is a schematic cross sectional view of a center console box in the first embodiment.

FIG. 5 is a first schematic cross sectional view of a portion of an air inlet duct of the electric power storage apparatus in the first embodiment.

FIG. 6 is a second schematic cross sectional view of the portion of the air inlet duct of the electric power storage apparatus in the first embodiment.

FIG. 7 is a schematic cross sectional view of a center console box as a comparative example.

FIG. 8 is a schematic cross sectional view of a cabin as a comparative example.

FIG. 9 is a schematic plan view of the cabin as the comparative example.

FIG. 10 is a schematic plan view of the cabin in the first embodiment.

FIG. 11 is an enlarged schematic cross sectional view of an air inlet port of an air inlet duct of a second electric power storage apparatus in the first embodiment.

FIG. 12 is a schematic cross sectional view of a portion of an air inlet duct of a third electric power storage apparatus in the first embodiment.

FIG. 13 is a first schematic perspective view illustrating a stacking direction of another electric power storage device in the first embodiment.

FIG. 14 is a first schematic perspective view illustrating a stacking direction of still another electric power storage device in the first embodiment.

FIG. 15 is a second schematic perspective view illustrating a stacking direction of yet another electric power storage device in the first embodiment.

FIG. 16 is a first schematic cross sectional view of a portion of an air inlet duct of a first electric power storage apparatus in a second embodiment.

FIG. 17 is a second schematic cross sectional view of the portion of the air inlet duct of the first electric power storage apparatus in the second embodiment.

FIG. 18 is an enlarged schematic cross sectional view of an air inlet port of the air inlet duct of the second electric power storage apparatus in the second embodiment.

FIG. 19 is a schematic cross sectional view of a portion of an air inlet duct in a first electric power storage apparatus in a third embodiment.

FIG. 20 is an enlarged schematic cross sectional view of an air inlet port of an air inlet duct of a second electric power storage apparatus in the third embodiment.

FIG. 21 is a schematic cross sectional view of a portion of an air inlet duct of an electric power storage apparatus in a fourth embodiment.

### BEST MODES FOR CARRYING OUT THE INVENTION

### First Embodiment

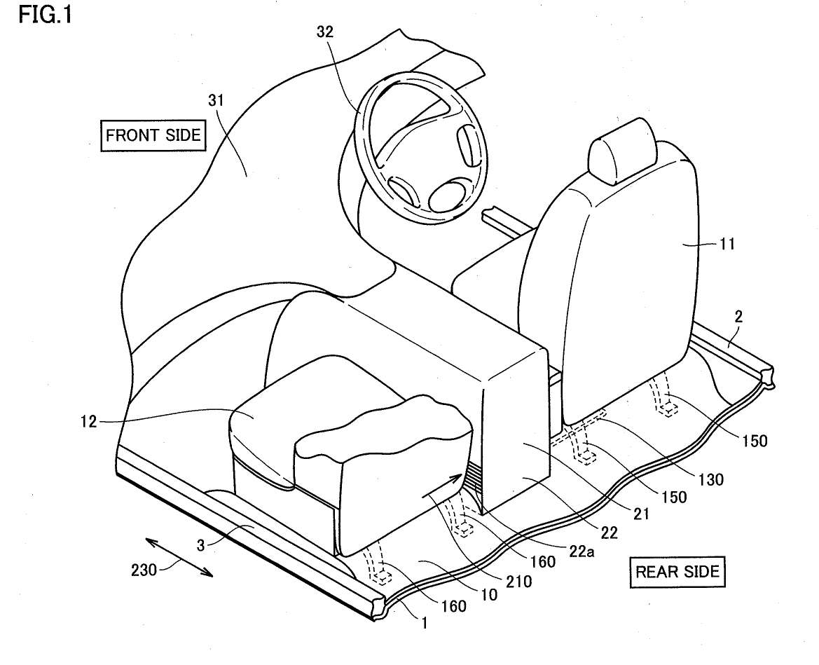

Referring to FIG. 1 to FIG. 15, an electric power storage apparatus in a first embodiment based on the present invention will be described. The electric power storage apparatus in the present embodiment is installed in a car serving as a vehicle. In the present embodiment, main units of the electric power storage apparatus are provided within a center console box positioned between a driver's seat and a passenger's seat.

FIG. 1 shows a schematic perspective view of a cabin in the present embodiment. FIG. 1 is a perspective view of a front end portion of the cabin. An arrow 230 indicates the front-back direction of the car body. In the front side of the cabin, a dashboard 31 is provided. In the front side of the cabin, driver's seat 11 and passenger's seat 12 serving as seats are provided. Driver's seat 11 and passenger's seat 12 are seats in the frontmost one of a plurality of rows. In front of driver's seat 11, a steering wheel 32 is provided.

Driver's seat 11 and passenger's seat 12 are fixed to a floor panel 1 via seat legs 150, 160 respectively. A floor carpet 10 is provided on a surface of floor panel 1. Seat legs 150, 160 are covered with floor carpet 10. In the lateral side relative to driver's seat 11 and the lateral side relative to passenger's seat 12, scuff plates 2, 3 are provided.

Provided between driver's seat 11 and passenger's seat 12 is center console box 21, which is formed to extend in the front-back direction of the car body. Center console box 21 includes an outer case 22. Outer case 22 has a lateral surface, on a rear portion of which an air intake port 22a is formed to draw air from the cabin into outer case 22. The air is drawn into center console box 21 via air intake port 22a as indicated by an arrow 210.

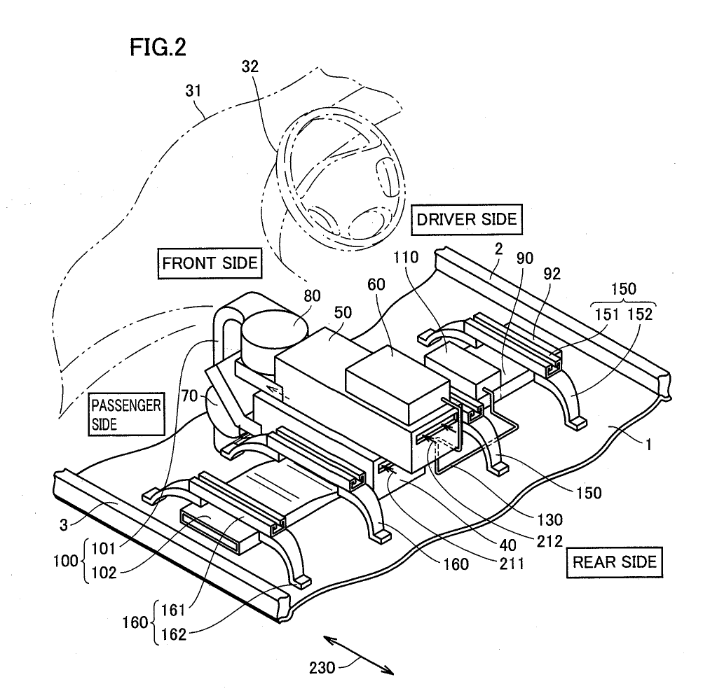

FIG. 2 shows a schematic perspective view of a first electric power storage apparatus provided within the center console box. The electric power storage apparatus in the present embodiment includes a first battery pack 40 serving as a storage pack. Further, the electric power storage apparatus in the present embodiment includes a second battery pack 50 serving as a storage pack. Second battery pack 50 is provided on first battery pack 40. On second battery pack 50, a junction box 60 is provided. Junction box 60 is electrically connected via a conductive wire 130 to a DC/DC converter 110 set at a first below-seat air outlet duct 92.

In front of first battery pack 40, a first cooling fan unit 70 is provided. To first cooling fan unit 70, a first air outlet duct 90 is connected. First air outlet duct 90 includes first below-seat air outlet duct 92 and a first center air outlet duct 91 described below. First below-seat air outlet duct 92 is formed to extend toward the driver's seat side. First below-seat air outlet duct 92 is formed to extend in the width direction of the car body.

In front of second battery pack 50, a second cooling fan unit 80 is provided. To second cooling fan unit 80, a second air outlet duct 100 is connected. Second air outlet duct 100 includes a second center air outlet duct 101 and a second below-seat air outlet duct 102. Second below-seat air outlet duct 102 is formed to extend toward the passenger's seat side. Second below-seat air outlet duct 102 is formed to extend in the width direction of the car body.

Seat legs 150 are a pair of seat legs provided at a predetermined interval in the width direction of the car body. Each of seat legs 150 includes a guide rail 151 and a semicircular foot portion 152. On guide rail 151, driver's seat 11 is mounted and is supported to be movable in the front-back direction.

Each of seat legs 160 has a configuration similar to that of each of seat legs 150. Seat legs 160 provided herein are a pair of seat legs. Each of seat legs 160 includes a guide rail 161 and a semicircular foot portion 162. On guide rail 161, passenger's seat 12 is mounted and is supported to be movable in the front-back direction.

First below-seat air outlet duct 92 is provided in a space surrounded by seat legs 150 and floor panel 1. First below-seat air outlet duct 92 has an air outlet port located below the driver's seat. First below-seat air outlet duct 92 has an air outlet path at which DC/DC converter 110 serving as an electric device is set. Second below-seat air outlet duct 102 is provided in a space surrounded by seat legs 160 and floor panel 1. Second below-seat air outlet duct 102 has an air outlet port located below the passenger's seat.

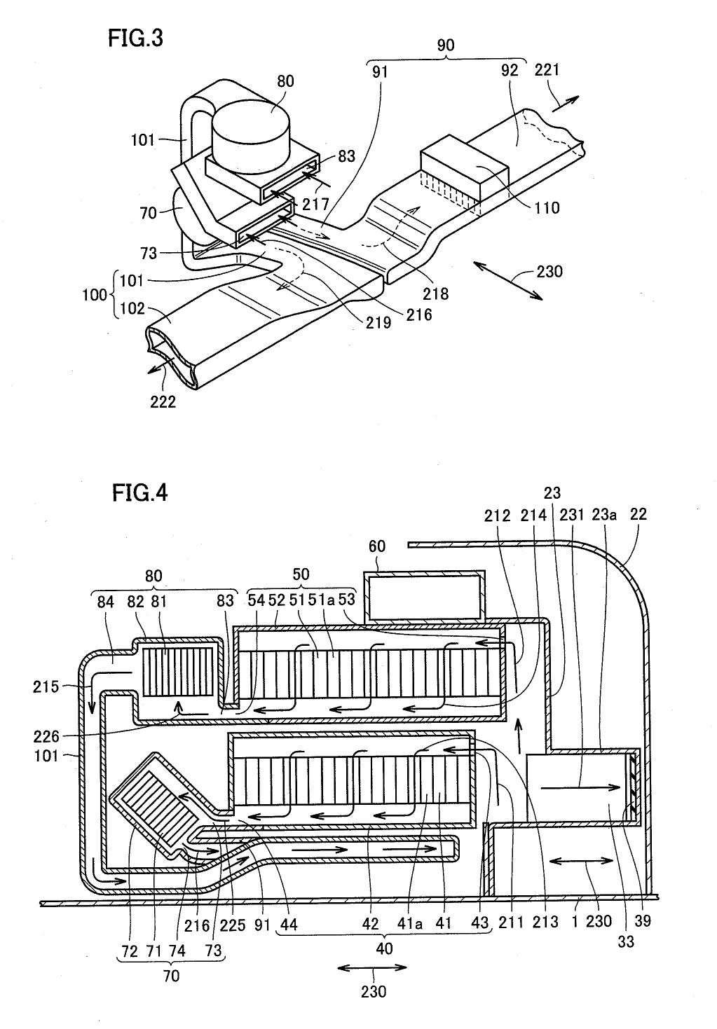

FIG. 3 shows a schematic perspective view of the ducts from which air is let out of the battery packs of the electric power storage apparatus. Referring to FIG. 2 and FIG. 3, a cooling device for first battery pack 40 includes first cooling fan unit 70 and first air outlet duct 90. First cooling fan unit 70 is connected to first battery pack 40. Air from first battery pack 40 flows thereinto via air intake port 73 as indicated by an arrow 216.

First air outlet duct 90 has first center air outlet duct 91. First center air outlet duct 91 is formed to extend from below first cooling fan unit 70 to below the first battery pack. First center air outlet duct 91 is connected to first below-seat air outlet duct 92.

DC/DC converter 110, set at the air outlet path of first below-seat air outlet duct 92, has a portion disposed within first below-seat air outlet duct 92. DC/DC converter 110 is cooled by air flowing in first below-seat air outlet duct 92.

A cooling device for second battery pack 50 includes second cooling fan unit 80 and second air outlet duct 100. Second cooling fan unit 80 is connected to second battery pack 50. Air from second battery pack 50 flows in via air intake port 83 as indicated by an arrow 217.

Second air outlet duct 100 has second center air outlet duct 101. Second center air outlet duct 101 is formed to extend from second cooling fan unit 80 to below first battery pack 40. Second center air outlet duct 101 is connected to second below-seat air outlet duct 102.

FIG. 4 shows a schematic cross sectional view of the center console box in the present embodiment. In outer case 22, there are arranged an inner case 23, first battery pack 40, second battery pack 50, first cooling fan unit 70, second cooling fan unit 80, a portion of the first air outlet duct, and a portion of the second air outlet duct. First battery pack 40 and second battery pack 50 are arranged side by side in the vertical direction.

Referring to FIG. 2 and FIG. 4, first battery pack 40 includes a storage battery 41 serving as an electric power storage device. Second battery pack 50 includes a storage battery 51 serving as an electric power storage device. Storage batteries 41, 51 employed herein are chargeable and dischargeable secondary batteries. Storage batteries 41, 51 in the present embodiment respectively include battery cells 41a, 51a both serving as storage cells. Storage battery 41 in the present embodiment includes a plurality of battery cells 41a. Storage battery 51 includes a plurality of battery cells 51a. Each of battery cells 41a, 51a is formed to have a plate-like shape. Battery cells 41a are stacked in one row, and the same holds true for battery cells 51a. The stacking direction of battery cells 41a, 51a in the present embodiment is the front-back direction of the car body, which is one direction. There are formed spaces between battery cells 41a, and between battery cells 51a. The stacking direction in the present embodiment indicates a direction in which the largest number of storage cells are arranged, among directions in which a plurality of storage cells are arranged.

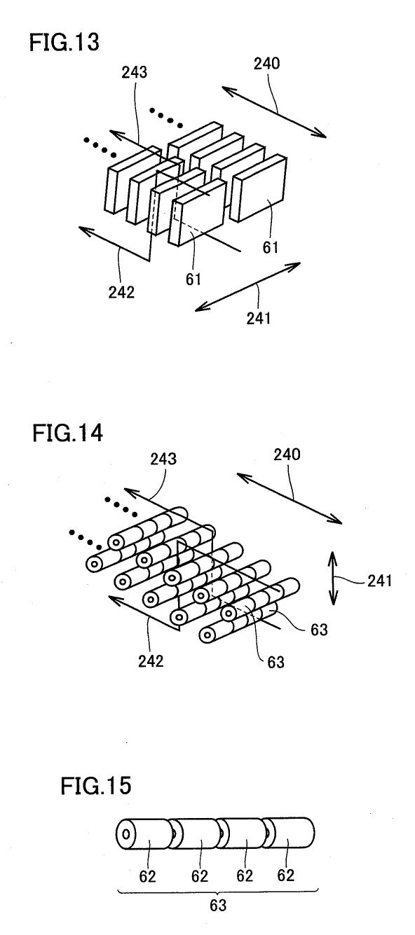

FIG. 13 to FIG. 15 show explanatory diagrams of the stacking direction in the present invention. FIG. 13 is a schematic perspective view of an electric power storage device in which flat plate-like storage cells are stacked in a plurality of rows. The electric power storage device shown in FIG. 13 includes storage cells 61 in two rows. An arrow 241 indicates a direction in which two storage cells 61 are arranged whereas an arrow 240 indicates a direction in which three or more storage cells 61 are arranged. In the present invention, the direction indicated by arrow 240 is the stacking direction of storage cells 61.

FIG. 14 is a schematic perspective view of an electric power storage device in which cylindrical storage cells are stacked in a plurality of rows. FIG. 15 is an enlarged schematic perspective view of each of the storage cells. Referring to FIG. 15, each storage cell 63 has a plurality of cylindrical battery elements 62. The plurality of battery elements 62 are arranged in series, thereby constituting storage cell 63. Referring to FIG. 14, storage cells 63 are arranged with their longitudinal sides facing one another. Storage cells 63 are arranged with their longitudinal sides being substantially in parallel with one another. This electric power storage device includes storage cells 63 arranged in two rows. An arrow 241 indicates a direction in which two storage cells 63 are arranged whereas an arrow 240 indicates a direction in which three or more storage cells 63 are arranged. In the present invention, the direction indicated by arrow 240 is the stacking direction of storage cells 63.

First battery pack 40 includes a storage battery case 42. Storage battery case 42 is formed to contain therein storage battery 41. Storage battery case 42 has an air intake port 43 on its rear surface in the front-back direction. Air intake port 43 is formed in the upper portion of storage battery case 42. Storage battery case 42 has an air exhaust port 44 formed to allow air to flow into first cooling fan unit 70. Air exhaust port 44 is formed in the lower portion of the front surface thereof.

Second battery pack 50 has a configuration similar to that of first battery pack 40. Second battery pack 50 includes a storage battery case 52. In storage battery case 52, storage battery 51 is provided. Storage battery case 52 has an air intake port 53 on its rear surface. Storage battery case 52 has an air exhaust port 54 formed to allow air to flow into second cooling fan unit 80.

First cooling fan unit 70 includes a fan case 72. First cooling fan unit 70 has a sirocco fan 71 serving as a blower. The sirocco fan is an air sending fan that draws air from the central portion of the rotary fan in the direction of the rotation axis and lets the air out in a direction perpendicular to the rotation axis. Sirocco fan 71 is provided within fan case 72. Sirocco fan 71 is formed to rotate to draw air from storage battery case 42 and bring the air into first center air outlet duct 91.

Fan case 72 has an air intake port 73. Air intake port 73 is in communication with air exhaust port 44 of storage battery case 42. Fan case 72 has an air exhaust port 74. Air exhaust port 74 is in communication with first center air outlet duct 91.

Second cooling fan unit 80 has a configuration similar to that of first cooling fan unit 70. Second cooling fan unit 80 includes a sirocco fan 81 and a fan case 82. Fan case 82 has an air intake port 83. Air intake port 83 is in communication with air exhaust port 54 of second battery pack 50. Fan case 82 has an air exhaust port 84. Air exhaust port 84 is connected to second center air outlet duct 101. Sirocco fan 81 is formed to draw air from storage battery case 52 and bring the air into second center air outlet duct 101.

Referring to FIG. 4, the electric power storage apparatus in the present embodiment includes inner case 23. Inner case 23 is provided within outer case 22. Inner case 23 is formed to cover respective end surfaces of first battery pack 40 and second battery pack 50. Inner case 23 is formed to supply the respective battery packs with air drawn from air intake port 22a of outer case 22.

Inner case 23 includes an air inlet duct 23a for sending air to first battery pack 40 and second battery pack 50. Air inlet duct 23a is formed to extend in the front-back direction of the car body, which is one direction.

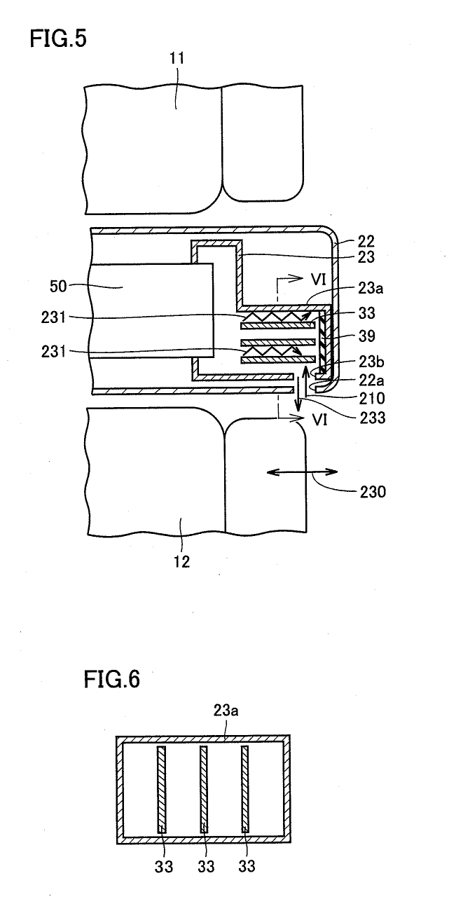

FIG. 5 shows a first schematic cross sectional view of a portion of the air inlet duct in the present embodiment. FIG. 5 is a schematic cross sectional view thereof when taken in the horizontal direction. FIG. 6 shows a second schematic cross sectional view of the portion of the air inlet duct in the present embodiment. FIG. 6 is a cross sectional view thereof taken along a line VI-VI in FIG. 5.

Referring to FIG. 4 to FIG. 6, air inlet duct 23a in the present embodiment is formed to have a tubular shape. Air inlet duct 23a has an air inlet port 23b serving as an opening. Air inlet port 23b is formed in a location corresponding to air intake port 22a of outer case 22. Air inlet port 23b is formed on an end portion of air inlet duct 23a. Among the wall surfaces of air inlet duct 23a, air inlet port 23b is formed on a wall surface substantially parallel to the direction in which air inlet duct 23a extends.

Air inlet port 23b is formed to allow air to flow in a direction perpendicular to the front-back direction of the car body as indicated by arrow 210. Air inlet port 23b is formed to allow air to flow in a direction perpendicular to the direction in which air inlet duct 23a extends.

The electric power storage apparatus in the present embodiment has a flow path plate 33 within air inlet duct 23a. Flow path plate 33 is formed to have a flat plate-like shape. Flow path plate 33 is disposed with its maximal-area surface being substantially parallel to the vertical direction. Flow path plate 33 is disposed with its maximal-area surface being in the front-back direction of the car body.

In the present embodiment, a plurality of flow path plates 33 are provided.

Flow path plates 33 are disposed with their maximal-area surfaces being substantially parallel to one another. The plurality of flow path plates 33 are arranged at a substantially equal interval therebetween.

The electric power storage apparatus in the present embodiment includes an acoustical material 39. Acoustical material 39 is provided on an end surface of air inlet duct 23a. Acoustical material 39 is provided on the end surface of air inlet duct 23a in the front-back direction of the car body. Acoustical material 39 is formed to have a plate-like shape. Acoustical material 39 is disposed with its maximal-area surface being substantially perpendicular to the direction in which air inlet duct 23a extends.

Referring to FIG. 5, as indicated by arrow 210, air in the cabin flows into air inlet duct 23a via air intake port 22a of outer case 22 and air inlet port 23b of inner case 23. The air passes through air inlet duct 23a and is supplied to first battery pack 40 and second battery pack 50.

Referring to FIG. 4 and FIG. 5, for cooling first battery pack 40, sirocco fan 71 is driven to allow air to flow into storage battery case 42 via air intake port 43 as indicated by an arrow 211. As indicated by an arrow 213, the air passes through the spaces between battery cells 41a, thereby cooling storage battery 41. In the present embodiment, storage battery 41 is cooled by air flowing in the direction perpendicular to the stacking direction. A portion of the air flowing in the stacking direction of battery cells 41 a flows from the upper surface to the lower surface, thereby cooling storage battery 41 in the present embodiment. As such, storage battery 41 in the present embodiment is cooled by airflow of so-called “down flow type”.

The air having cooled storage battery 41 flows into sirocco fan 71 as indicated by an arrow 225. The air is then brought from sirocco fan 71 into first center air outlet duct 91 as indicated by an arrow 216.

The airflow for cooling the storage battery is not limited to this form but may be, for example, airflow from the lower surface to the upper surface of the storage battery. The electric power storage apparatus may be configured so that the electric power storage device is cooled by airflow of so-called “upper flow type”.

Referring to FIG. 13, the electric power storage device in which flat plate-like storage cells 61 are provided in the plurality of rows may be configured so that, for example, cooling air flows in the down flow type manner as indicated by an arrow 242. Alternatively, as indicated by an arrow 243, it may be configured so that the air flows in the upper flow type manner.

Referring to FIG. 14, the electric power storage device in which cylindrical storage cells 63 are provided in the plurality of rows may be configured so that, for example, cooling air flows in the down flow type manner as indicated by arrow 242. Alternatively, as indicated by arrow 243, it may be configured so that the air flows in the upper flow type manner.

Referring to FIG. 3, as indicated by an arrow 218, the air having cooled the first battery pack flows in first below-seat air outlet duct 92, thus cooling DC/DC converter 110. The air having cooled DC/DC converter 110 is let out between the floor panel and the floor carpet as indicated by an arrow 221.

Referring to FIG. 4, for cooling second battery pack 50, sirocco fan 81 is driven to allow air to flow into storage battery case 52 as indicated by arrows 212, 214, thereby cooling storage battery 51. Storage battery 51 in the present embodiment is cooled by airflow of down flow type. The air having cooled storage battery 51 flows into sirocco fan 81 as indicated by an arrow 226, and is thereafter brought into second center air outlet duct 101 as indicated by an arrow 215.

Referring to FIG. 3, the air brought into second center air outlet duct 101 flows into second below-seat air outlet duct 102 as indicated by an arrow 219. The air flowing in second below-seat air outlet duct 102 is let out between the floor panel and the floor carpet as indicated by an arrow 222.

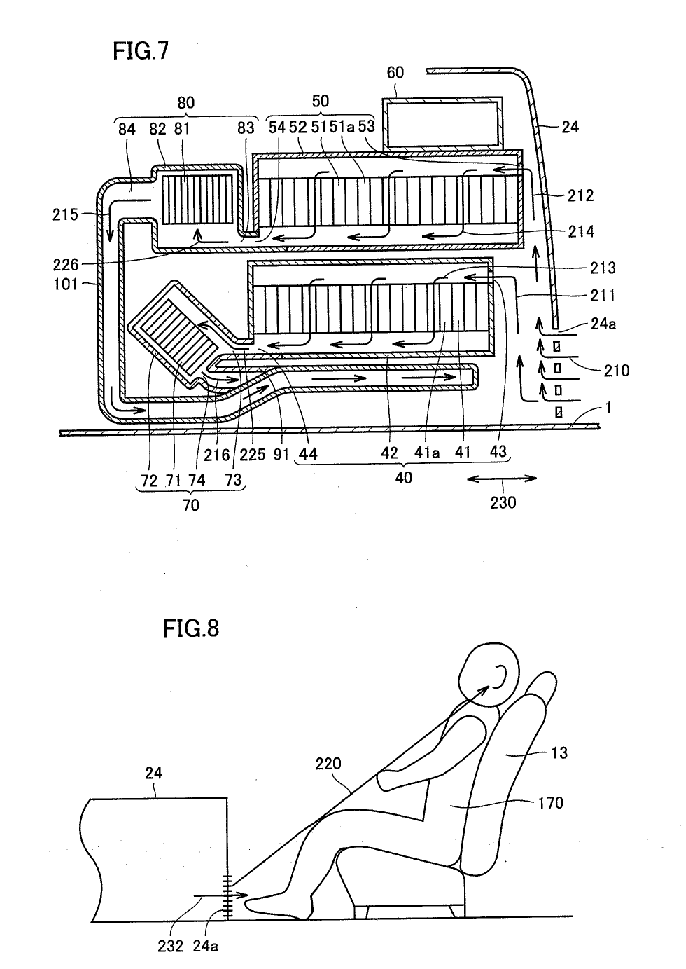

Now, referring to FIG. 7 to FIG. 9, the following explains an electric power storage apparatus as a comparative example in the present embodiment. FIG. 7 is a schematic cross sectional view of the electric power storage apparatus serving as the comparative example in the present embodiment. The electric power storage apparatus serving as the comparative example includes an outer case 24. The electric power storage apparatus of the comparative example includes no inner case and has flow paths for drawn air, which are formed by spaces between the end surface of first battery pack 40 and outer case 24 and between the end surface of second battery pack 50 and outer case 24,

Outer case 24 has an air intake port 24a. Air intake port 24a is disposed in the rear side in the front-back direction of the car body. Air intake port 24a is disposed in the lower portion of outer case 24. Air intake port 24a is disposed in the rear end surface of outer case 24. In the electric power storage apparatus of the comparative example, air for cooling first battery pack 40 and second battery pack 50 is drawn from air intake port 24a as indicated by an arrow 210. The air flows into respective air intake ports 43, 53.

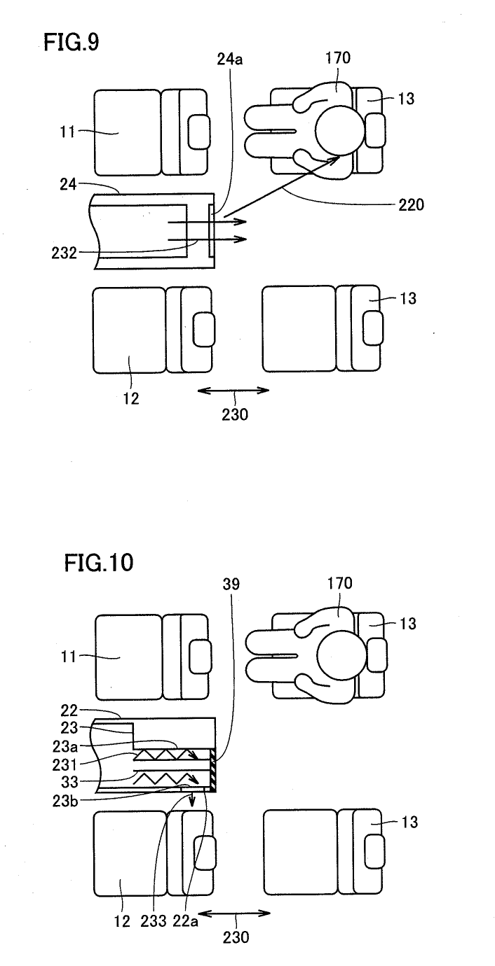

FIG. 8 shows a schematic cross sectional view of a cabin of a car as a comparative example. FIG. 9 shows a schematic plan view of the cabin of the car as the comparative example. The electric power storage apparatus serving as the comparative example is positioned between the driver's seat and the passenger's seat, which are seats in the frontmost row.

The car as the comparative example includes, in addition to driver's seat 11 and passenger's seat 12, a backseat 13. Backseat 13 is a seat in the second row. Backseat 13 is located behind the center console box.

By driving the electric power storage apparatus, high frequency noise resulting from ripple current or the like is generated. Otherwise, noise resulting from driving of the fans is generated. The ripple current is generated by, for example, driving of a relay, an inverter, or the like in the electric power storage apparatus. Such generated noise is, for example, a high frequency sound of approximately 10 kHz.

Referring to FIG. 8 and FIG. 9, noise is emitted toward the rear side via air intake port 24a as indicated by an arrow 232. The noise linearly reaches an ear of an occupant 170 sitting on backseat 13, as indicated by an arrow 220. Thus, the occupant sitting on backseat 13 hears such noise well.

FIG. 10 shows a schematic plan view of the cabin of the car in the present embodiment. The electric power storage apparatus in the present embodiment has air inlet duct 23a in the flow paths for drawing air. Air inlet port 23b of air inlet duct 23a is formed to allow air to flow in the width direction of the car body.

Referring to FIG. 4, FIG. 5, and FIG. 10, among the noise, the high frequency noise resulting from ripple current or the like has a high directivity. In the electric power storage apparatus in the present embodiment, air inlet duct 23a is formed to extend in the front-back direction of the car body, and air inlet port 23b is formed to allow air to flow in a direction perpendicular to the direction in which air inlet duct 23a extends. The noise travels in the direction in which air inlet duct 23a extends as indicated by arrows 231 and hits against the end surface of air inlet duct 23a. This can restrain leakage of the noise from air inlet port 23b.

Air inlet port 23b in the present embodiment is formed to open in the width direction of the vehicle, so the noise is emitted in the width direction of the car body as indicated by an arrow 233. As a result, the noise can be prevented from reaching backseat 13 linearly. The noise audible for the occupant sitting on backseat 13 can be suppressed.

In the present embodiment, flow path plates 33 are provided within air inlet duct 23a to form the respective flow paths for air. Noise travels within the flow paths separated by air inlet duct 23a and flow path plates 33, as indicated by arrows 231. The noise travels along the flow paths to the end surface of air inlet duct 23a more securely, thus achieving more effective restraint of leakage of the noise out of air inlet port 23b.

Further, in the present embodiment, acoustical material 39 is provided on the end surface of air inlet duct 23a, so the noise traveling the flow paths for air hits against acoustical material 39 and is absorbed in acoustical material 39. In this way, acoustical material 39 provided on the end surface of the air inlet duct can achieve more effective suppression of noise.

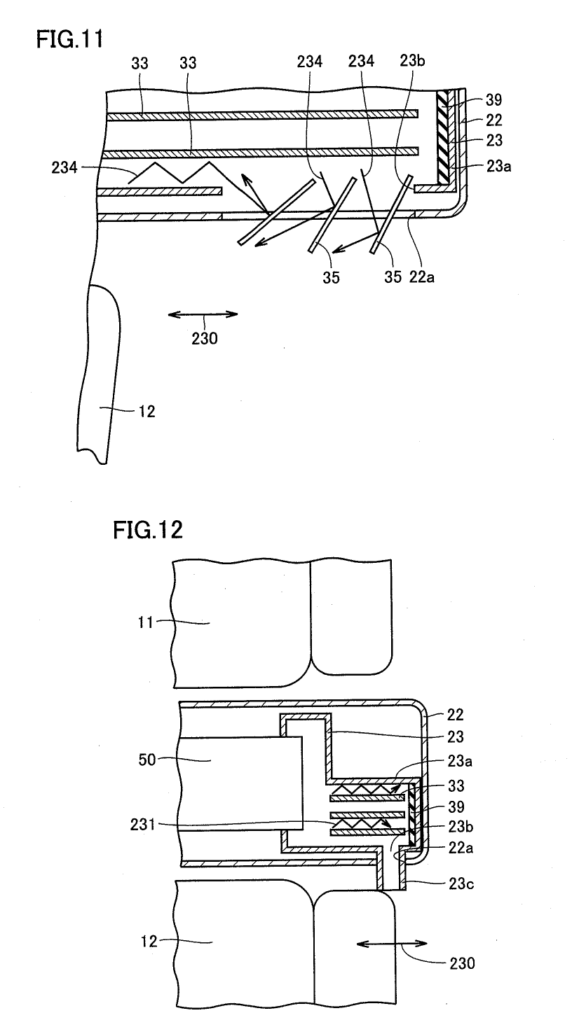

FIG. 11 shows an enlarged schematic cross sectional view of a portion of an air inlet port of a second electric power storage apparatus in the present embodiment. In the second electric power storage apparatus, air inlet port 23b of air inlet duct 23a is provided with reflecting members 35. Each of reflecting members 35 in the present embodiment is formed to have a plate-like shape. Reflecting members 35 are disposed with their maximal-area surfaces inclining relative to the car body's front-back direction indicated by arrow 230. A maximal-area surface refers to a surface having the maximal area.

Reflecting members 35 are disposed to reflect, using the surfaces, the noise leaking out of air inlet port 23b toward the front side of the car body. Alternatively, they are disposed to reflect, using the surfaces of reflecting members 35, the noise back to the inside of air inlet duct 23a.

By providing reflecting members 35 in air inlet port 23b to reflect the noise, as indicated by arrows 234, noise leaking out of air inlet port 23b can be reflected toward the front side of the car body or can be reflected back to the inside of air inlet duct 23a. As a result, the noise can be prevented more effectively from reaching the occupant.

If the reflecting members are provided in the air inlet port, a mesh member may be provided to cover the air inlet port. For example, a wire mesh may be provided. With this configuration, a cup holder, a container, or the like can be prevented from being attached to the reflecting members by pinching the reflecting members to fixate themselves thereto. This can prevent reduction of the area of the opening of the air inlet port.

FIG. 12 shows a schematic cross sectional view of a portion of an air inlet duct of a third electric power storage apparatus in the present embodiment. FIG. 12 is a schematic cross sectional view thereof when the electric power storage apparatus is taken along the horizontal plane. In the third electric power storage apparatus of the present embodiment, an extending duct 23c is connected to air inlet port 23b of air inlet duct 23a. Extending duct 23c in the present embodiment is formed to extend in the width direction of the car body. As such, the extending duct may be connected to the opening of the duct.

Extending duct 23c in the present embodiment is formed to extend toward the rear side of passenger's seat 12. The extending duct is not limited to this form but may be formed to extend to below any of the seats. With this configuration, the opening of the extending duct can be located below a seat, thus making it more difficult that the noise leaking out of the extending duct reaches an occupant. This allows further noise reduction in the cabin.

Each of the flow path plates in the present embodiment is formed to have a flat plate-like shape but is not limited to this form. They may be in any form as long as they constitute flow paths in a direction substantially parallel to the direction in which the duct extends. For example, the flow path plates may be formed to have curved maximal-area surfaces.

Further, each of the reflecting members in the present embodiment is formed to have a flat plate-like shape but is not limited to this form. Reflecting members of any shape can be employed.

Further, in the present embodiment, the air inlet duct is formed to extend in one direction, and the air inlet port is formed in the air inlet duct. However, the present invention is not limited to this form and is applicable to the air outlet duct. For example, the air outlet duct may be formed to extend in one direction, and the air outlet port of the air outlet duct may be formed to allow air to flow in a direction substantially perpendicular to the one direction.

Further, the electric power storage apparatus in the present embodiment is positioned between the driver's seat and the passenger's seat, which are seats in the frontmost one of the plurality of rows of seats, but is not limited to this form and can be positioned in any location. For example, if there are three rows of seats, the electric power storage apparatus may be positioned between seats in the second row.

Furthermore, the duct in the present embodiment for reducing noise is formed to extend in the front-back direction of the car body but is not limited to this form and may be formed to extend in any direction.

The electric power storage apparatus in the present embodiment includes the acoustical material, but is not limited to this form and no acoustical material may be provided. Further, the acoustical material in the present embodiment is provided on the end surface of the air inlet duct as seen in the direction in which the duct extends but is not limited to this form, and the acoustical material can be provided in any portion. For example, the acoustical material may be provided on the entire internal surface of the air inlet duct.

The electric power storage device in the present embodiment includes the storage batteries. The electric power storage device is not limited to this form but may be any device as long as it is capable of storing electric power. For example, the electric power storage device may include a capacitor.

In the present embodiment, the electric power storage apparatus includes the two battery packs and the cooling flow paths are formed for the battery packs respectively. However, it is not limited to this form. The electric power storage device can be cooled in any form. For example, a plurality of storage batteries may be contained in one battery case. Alternatively, air going out of the respective battery packs may be jointed in one flow path.

### Second Embodiment

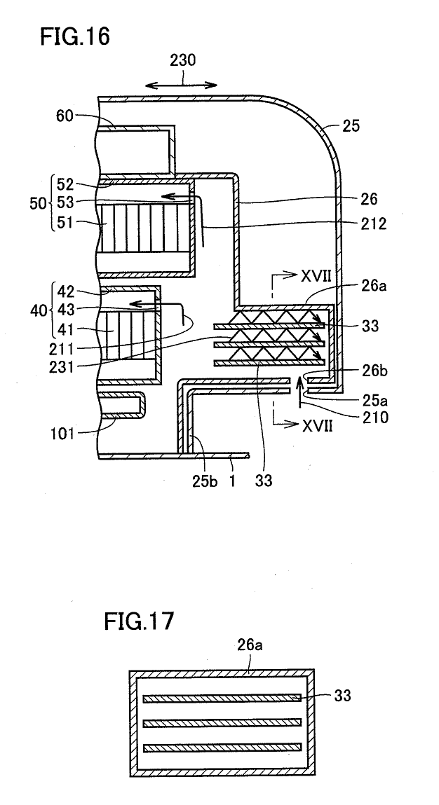

Referring to FIG. 16 to FIG. 18, an electric power storage apparatus in a second embodiment based on the present invention will be described. FIG. 16 is a schematic cross sectional view of the electric power storage apparatus in the present embodiment. FIG. 16 is a schematic cross sectional view thereof when taken along a plane extending in the vertical direction. The electric power storage apparatus in the present embodiment is provided in a car.

The electric power storage apparatus in the present embodiment includes an outer case 25. Outer case 25 has an air intake port 25a. Air intake port 25a is provided to face downward. Air intake port 25a is formed to face floor panel 1 serving as a floor member.

Outer case 25 has a recess portion 25b. Recess portion 25b is formed on the bottom portion of outer case 25. Recess portion 25b formed herein is a portion sunken toward the front side of the car body. In recess portion 25b, air intake port 25a is formed.

The electric power storage apparatus in the present embodiment includes an inner case 26. Inner case 26 is provided within outer case 25. Inner case 26 has an air inlet duct 26a. Air inlet duct 26a is formed to extend in the car body's front-back direction indicated by arrow 230.

Air inlet duct 26a has an air inlet port 26b. Air inlet port 26b is formed in a location corresponding to air intake port 25a. Air inlet port 26b is formed to face downward. Air inlet port 26b is formed to allow air to flow in a direction perpendicular to the front-back direction of the car body as indicated by arrow 210. Air inlet port 26b is formed to face floor panel 1.

FIG. 17 shows a schematic cross sectional view of a portion of the air inlet duct in the present embodiment. FIG. 17 is a cross sectional view thereof taken along a line XVII-XVII in FIG. 16. Referring to FIG. 16 and FIG. 17, the electric power storage apparatus in the present embodiment includes a flow path plate 33. Flow path plate 33 is formed to have a flat plate-like shape. Flow path plate 33 in the present embodiment is formed with its maximal-area surface being substantially parallel to the horizontal direction. The electric power storage apparatus in the present embodiment includes a plurality of flow path plates 33. The plurality of flow path plates 33 are disposed with their maximal-area surfaces being substantially parallel to one another.

Referring to FIG. 16, noise travels in flow paths formed by air inlet duct 26a and flow path plates 33, as indicated by arrows 231. High frequency noise has a high directivity, so it travels linearly in the respective flow paths and hits against the end surface of air inlet duct 26a. This can restrain leakage of noise from air inlet port 26b of the air inlet duct.

Further, in the present embodiment, air inlet port 26b is formed to face downward. Accordingly, the noise leaking out of air inlet port 26b travels downward and hits against floor panel 1. This can prevent the noise leaking out of air inlet port 26b from linearly reaching an ear of an occupant, thereby achieving more effective suppression of noise audible for the occupant.

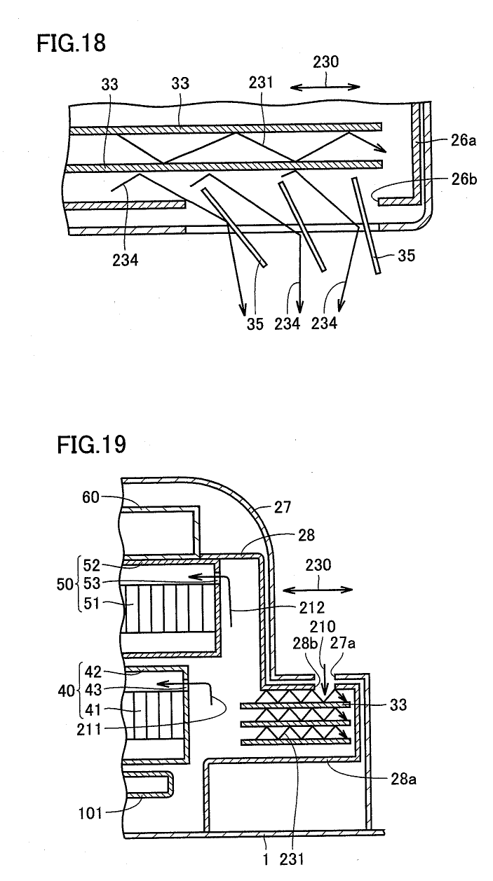

FIG. 18 shows an enlarged schematic cross sectional view of a portion of the air inlet port of the second electric power storage apparatus in the present embodiment. In the second electric power storage apparatus of the present embodiment, air inlet port 26b of air inlet duct 26a is provided with a plurality of reflecting members 35. Each of reflecting members 35 in the present embodiment is formed to have a flat plate-like shape.

Reflecting members 35 are provided so that the surfaces of reflecting members 35 reflect the noise, leaking out of air inlet port 26b, in the downward direction or toward the front side of the car body, or reflecting members 35 are provided so that the surfaces of reflecting members 35 reflect the noise back to the inside of air inlet duct 26a.

Each of reflecting members 35 is disposed with its maximal-area surface inclining relative to the car body's front-back direction indicated by arrow 230. The noise traveling within air inlet duct 26a is reflected by the surfaces of reflecting members 35 as indicated by arrows 234, thus traveling downward or toward the front side of the car body. This can prevent the noise more effectively from reaching the occupant.

Other configurations, functions, and effects are the same as those of the first embodiment, so explanation therefor is not repeated.

### Third Embodiment

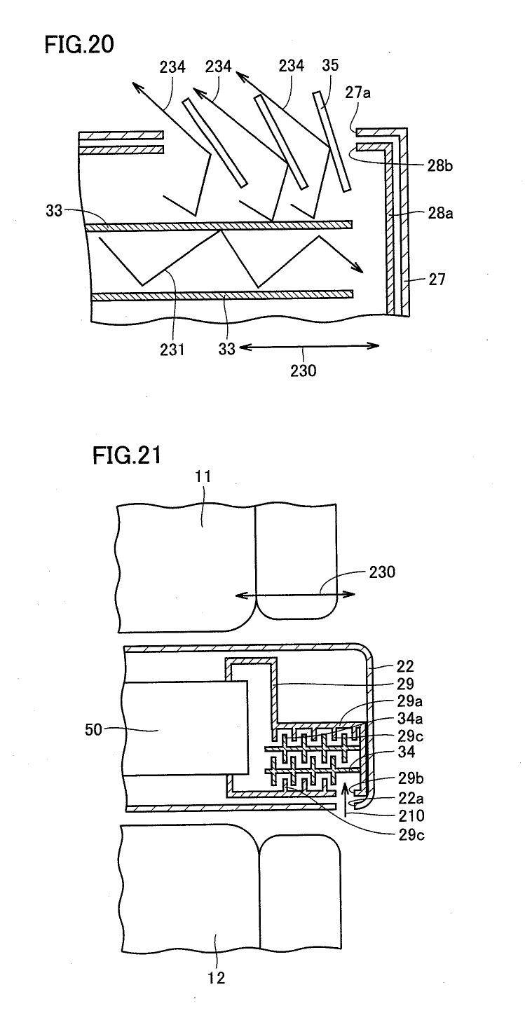

Referring to FIG. 19 and FIG. 20, an electric power storage apparatus in a third embodiment based on the present invention will be described. In the electric power storage apparatus in the present embodiment, an extending air inlet duct has an air inlet port formed to face upward.

FIG. 19 shows a schematic cross sectional view of a portion of an air inlet duct of a first electric power storage apparatus in the present embodiment. The first electric power storage apparatus in the present embodiment includes an outer case 27. Outer case 27 has an air intake port 27a. Air intake port 27a is formed to face upward.

The electric power storage apparatus in the present embodiment includes an inner case 28. Inner case 28 has an air inlet duct 28a. Air inlet duct 28a is formed to extend in the car body's front-back direction indicated by arrow 230. Air inlet duct 28a has an air inlet port 28b in its end portion. Air inlet port 28b is formed in a location corresponding to air intake port 27a. Air inlet port 28b is formed to allow air to flow in a direction perpendicular to the front-back direction of the car body as indicated by arrow 210.

The electric power storage apparatus in the present embodiment includes flow path plates 33. Each of flow path plates 33 is formed to have a flat plate-like shape. Flow path plates 33 are formed with their maximal-area surfaces extending in the horizontal direction.

FIG. 20 shows an enlarged schematic cross sectional view of a portion of an air inlet port of an air inlet duct of a second electric power storage apparatus in the present embodiment. The second electric power storage apparatus in the present embodiment includes reflecting members 35. Each of reflecting members 35 is formed to have a flat plate-like shape. Reflecting members 35 are formed to reflect noise, leaking out of air inlet port 28b, toward the front side of the car body as indicated by arrows 234. Alternatively, reflecting members 35 are disposed so that their maximal-area surfaces reflect the noise, leaking out of air inlet port 28b, back to the inside of air inlet duct 28a.

Also in the electric power storage apparatus in the present embodiment, the noise in the cabin can be suppressed. Other configurations, functions, and effects are the same as those of the first or second embodiment, so explanation therefor is not repeated.

### Fourth Embodiment

Referring to FIG. 21, an electric power storage apparatus in a fourth embodiment based on the present invention will be described. In the present embodiment, the respective shapes of an air inlet duct and a flow path member are different from those in first embodiment.

FIG. 21 is a schematic cross sectional view of a portion of the air inlet duct of the electric power storage apparatus in the present embodiment. FIG. 21 is a schematic cross sectional view thereof when the electric power storage apparatus is taken in the horizontal direction. The electric power storage apparatus in the present embodiment includes an inner case 29. Inner case 29 has air inlet duct 29a. Air inlet duct 29a has an air inlet port 29b.

Air inlet duct 29a in the present embodiment has projecting portions 29c formed to project inwardly. Projecting portions 29c are formed to project from wall surfaces of air inlet duct 29a. Each of projecting portions 29c formed herein has a plate-like shape. Projecting portions 29c are disposed with their maximal-area surfaces being substantially parallel to the vertical direction.

The electric power storage apparatus in the present embodiment includes flow path plates 34. Each of flow path plates 34 is formed to have a plate-like shape. Flow path plates 34 in the present embodiment have projecting portions 34a projecting in a direction perpendicular to the direction in which air inlet duct 29a extends. Each of projecting portions 34a is formed to have a plate-like shape. Projecting portions 34a are disposed with their maximal-area surfaces being substantially parallel to the vertical direction.

Projecting portions 29c and projecting portions 34a are formed alternately not to overlap with one another along the extension of air inlet duct 29a. In air inlet duct 29a in the present embodiment, the internal flow paths are formed in a labyrinth manner.

In the electric power storage apparatus in the present embodiment, the respective air flow paths formed in air inlet duct 29a are curved, so high frequency noise having a strong directivity can be prevented more effectively from reaching air inlet port 29b.

Other configurations, functions, and effects are the same as those of any of the first to third embodiments, so explanation therefor is not repeated.

The same or equivalent portions in the drawings described above are given the same reference characters.

The embodiments disclosed herein are illustrative and non-restrictive in any respect. The scope of the present invention is defined by the scope of claims rather than the above description, and is intended to include any modifications within the scope and meaning equivalent to the terms of the claims.

### INDUSTRIAL APPLICABILITY

The present invention is suitable for an electric power storage apparatus and a car.

1-10. (canceled)

11. An electric power storage apparatus provided in a cabin of a vehicle having a plurality of seats arranged in a width direction of a car body, comprising:
an electric power storage device, provided between said seats, for storing electric power; and
a duct, in which air flows to cool said electric power storage device, wherein:
said duct is formed between said seats in a direction extending in a front-back direction of said car body, and said duct has an end portion having an opening formed within said cabin to open in the width direction of said car body.

12. The electric power storage apparatus according to claim 11, comprising a flow path plate provided within said duct,
wherein said flow path plate is formed to extend in said front-back direction of said car body.

13. The electric power storage apparatus according to claim 11, wherein:
said opening includes one of an air inlet port and an air outlet port, and
said duct includes one of an air inlet duct and an air outlet duct.

14. The electric power storage apparatus according to claim 11, comprising an acoustical material for absorbing noise,
wherein said opening is formed on a wall surface of said duct, the wall surface is substantially parallel to said front-back direction of said car body, and said acoustical material is provided on an end surface of said duct in said front-back direction of said car body.

15. The electric power storage apparatus according to claim 11, comprising a reflecting member for reflecting noise, wherein:
said reflecting member is provided in said opening,
said reflecting member is formed to have a plate-like shape, and
said reflecting member has a surface having a maximal area and is disposed with the surface inclining relative to said front-back direction of said car body.

16. The electric power storage apparatus according to claim 11, wherein: said electric power storage device includes a plurality of storage cells, and
in said electric power storage device, said plurality of storage cells are stacked in said front-back direction of said car body.

17. A car, comprising the electric power storage apparatus according to claim 11.

18. A car comprising an electric power storage apparatus provided in a cabin of a vehicle having a plurality of seats arranged in a width direction of a car body; and a floor member provided within said cabin, wherein:
said electric power storage apparatus comprises an electric power storage device, provided between said seats, for storing electric power, and a duct in which air flows to cool said electric power storage device, and
said duct is formed between said seats to extend in a front-back direction of said car body, and said duct has an end portion having an opening formed within said cabin to face downward in a vertical direction and to face said floor member.

19. A car comprising an electric power storage apparatus provided in a cabin of a vehicle having a plurality of seats arranged in a width direction of a car body, wherein:
said electric power storage apparatus comprises an electric power storage device, provided between said seats, for storing electric power, and a duct in which air flows to cool said electric power storage device,
said duct is formed between said seats to extend in a front-back direction of said car body, said duct has an end portion having an opening formed within said cabin to open in the width direction of said car body, an extending duct is formed in said opening of said duct to extend in the width direction of said car body, and
said extending duct has a tip portion formed to extend to below said seats.
